(19) United States
(12) Patent Application Publication
(10) Pub. No.: US 2023/0239662 A1
(43) Pub. Date: Jul. 27, 2023

(54) APPARATUS AND METHOD FOR RECOVERING MULTICAST SERVICE AFTER AN RELEASE IN MULTICAST SUPPORTING NETWORK IN WIRELESS COMMUNICATION SYSTEM

(71) Applicant: Samsung Electronics Co., Ltd., Suwon-si (KR)

(72) Inventor: Youngkyo BAEK, Suwon-si (KR)

(21) Appl. No.: 18/160,896

(22) Filed: Jan. 27, 2023

(30) Foreign Application Priority Data
Jan. 27, 2022 (KR) 10-2022-0012621

(51) Int. Cl. H04W 4/06; H04W 76/20; H04W 76/30

(52) U.S. Cl. CPC H04W 4/06; H04W 76/20; H04W 76/30

(57) ABSTRACT

The present disclosure relates to a 5G or 6G communication system for supporting a higher data transmission rate. A method performed by a session management function (SMF) in a mobile network is provided. The method may include receiving an information on a multicast/broadcast service protocol data unit (MBS PDU) session with a user equipment (UE) in an idle state, the MBS PDU session being in an active state, and transmitting, to an access and mobility management function (AMF), an information indicating that the UE in the idle state joins the MBS PDU session. The information indicating that the UE joins the MBS PDU session is used for a radio resource control (RRC) connection reconfiguration with the UE in the idle state.

### CROSS-REFERENCE TO RELATED APPLICATION

This application is based on and claims priority under 35 U.S.C. § 119 to Korean Patent Application No. 10-2022-0012621, filed on Jan. 27, 2022, in the Korean Intellectual Property Office, the present disclosure of which is herein incorporated by reference in its entirety.

### BACKGROUND

### 1. Field

The present disclosure generally relates to a wireless communication system, and more particularly, to a method for continuing a multicast service when access network (AN) release is needed in a process of transmitting multicast data to a terminal in a wireless communication system, and to a method and an apparatus for smooth multicast data transmission to a terminal in a fifth generation (5G) network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The disclosure presented hereinbelow provides a method and an apparatus for receiving a multicast service again when a terminal, which has joined a multicast service and has received the service in a mobile communication system providing the multicast service, transits (or, switches) to a idle state through an AN release process, and is not able to receive the multicast service.

### SUMMARY

According to an embodiment, a method performed by a session management function (SMF) in a mobile communication system is provided. The method may comprise receiving information for a multicast/broadcast service protocol data unit (MBS PDU) session associated with a user equipment (UE) in an idle state, the MBS PDU session being in an active state and transmitting, to an access and mobility management function (AMF), information indicating that the UE in the idle state joins the MBS PDU session. The information indicating that the UE joins the MBS PDU session is used for a radio resource control (RRC) connection reconfiguration with the UE in the idle state.

According to an embodiment, a session management function (SMF) in a mobile communication system is provided. The SMF comprises a transceiver and a controller coupled to the transceiver. The controller is configured to receive information for a multicast/broadcast service protocol data unit (MBS PDU) session associated with a user equipment (UE) in an idle state, the MBS PDU session being in an active state, and transmit, to an access and mobility management function (AMF), information indicating that the UE in the idle state joins the MBS PDU session. The information indicating that the UE joins the MBS PDU session is used for a radio resource control (RRC) connection reconfiguration with the UE in the idle state.

According to an embodiment, a method performed by an access and mobility management function (AMF) in a mobile communication system is provided. The method comprises transmitting, to a session management function (SMF), information for a multicast/broadcast service protocol data unit (MBS PDU) session associated with a user equipment (UE) in an idle state, the MBS PDU session being in an active state and receiving, from the SMF, information indicating that the UE in the idle state joins the MBS PDU session. The information indicating that the UE joins the MBS PDU session is used for a radio resource control (RRC) connection reconfiguration with the UE in the idle state.

According to an embodiment, an access and mobility management function (AMF) in a mobile communication system is provided. The AMF comprises a transceiver and a controller coupled to the transceiver. The controller is configured to transmit, to a session management function (SMF), information for a multicast/broadcast service protocol data unit (MBS PDU) session associated with a user equipment (UE) in an idle state, the MBS PDU session being in an active state and receive, from the SMF, information indicating that the UE in the idle state joins the MBS PDU session. The information indicating that the UE joins the MBS PDU session is used for a radio resource control (RRC) connection reconfiguration with the UE in the idle state.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a 5G system structure for a multicast service in a wireless communication system according to various embodiments of the present disclosure;

FIG. 2 illustrate a state in which a terminal which has received a multicast service in a wireless communication system does not continuously receive the multicast service when AN release is performed according to various embodiments of the present disclosure;

FIG. 3 illustrate a signal flowchart for a state in which a terminal which has received a multicast service in a wireless communication system does not continuously receive the multicast service when AN release is performed according to various embodiments of the present disclosure;

FIG. 4 illustrate a process of recovering a multicast service by requesting in a network after AN release is performed when a multicast session is activated in a wireless communication system according to various embodiments of the present disclosure;

FIG. 5 illustrate a process of continuing a multicast service by maintaining an associated protocol data unit (PDU) session in a network when a multicast session is activated and AN release may be performed in a wireless communication system according to various embodiments of the present disclosure;

FIG. 6 illustrate a process of recovering a multicast service by requesting by a terminal after AN release is performed when a multicast session is activated in a wireless communication system according to various embodiments of the present disclosure;

FIG. 7 illustrate a process of recovering a multicast service by a requesting by a terminal after AN release is performed when a multicast session is activated in a wireless communication system according to various embodiments of the present disclosure;

FIG. 8 illustrate a structure of a terminal according to various embodiments of the present disclosure;

FIG. 9 illustrate a structure of a base station according to various embodiments of the present disclosure; and

FIG. 10 illustrate a structure of a network entity according to various embodiments of the present disclosure.

### DETAILED DESCRIPTION

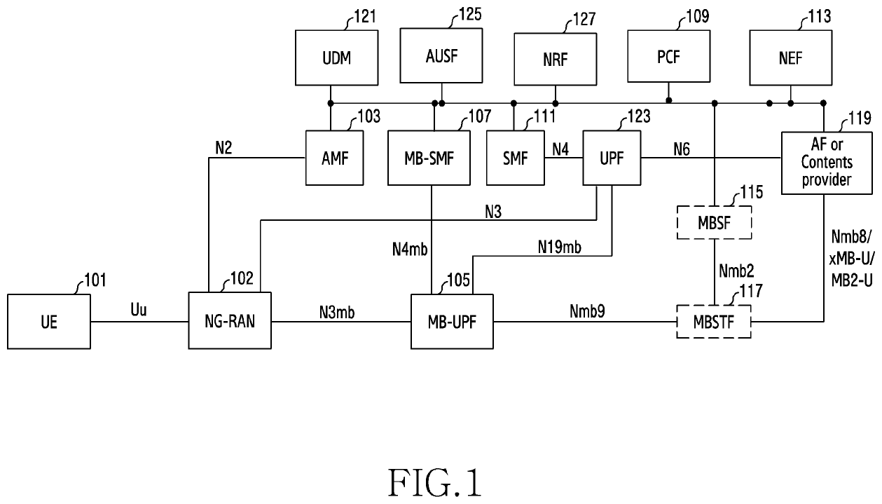

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The present disclosure relates to a method for continuing a multicast service when AN release is needed in a process of transmitting multicast data to a terminal in a wireless communication system, and provides a method and an apparatus for smooth multicast data transmission to a terminal in a 5G network.

In addition, the present disclosure provides a method and an apparatus for receiving a multicast service again when a terminal, which has joined a multicast service and has received the service in a mobile communication system providing the multicast service, transits (or, switches) to a idle state (or, dormant state) through an AN release process, and is not able to receive the multicast service.

In addition, the present disclosure provides a method and an apparatus for continuously and smoothly receiving a multicast service by deferring application of AN release when it is identified that AN release is needed for a terminal, which has joined a multicast service and has received the service in a mobile communication system providing the multicast service, and it is identified that the multicast service is activated.

According to various embodiments of the present disclosure, an operating method of a base station in a wireless communication system may include: identifying, by the base station, that AN release is needed for a terminal; transmitting a message for connection release to an access and mobility function (AMF); receiving a command message for connection release from the AMF; and performing, by the terminal, connection release from a radio access network (RAN).

According to various embodiments of the present disclosure, an operating method of an AMF in a wireless communication system may include: receiving a message for connection release from a base station; transmitting a command message for connection release to the base station; and receiving information regarding a multicast session for activating a protocol data unit (PDU) session again from a session management function (SMF).

Hereinafter, the operation principle of the present disclosure will be described in detail with reference to the accompanying drawings. In the following descriptions, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein should be understood based on the descriptions made herein.

As used herein, terms for identifying an access node, terms indicating network entities (NFs), terms indicating messages, terms indicating interfaces between NFs, terms indicating a variety of identification information are merely examples for convenience of explanation. Accordingly, the present disclosure is not limited to the terms described below, and other terms indicating objects having the same technical meanings may be used.

The terms used in the present disclosure are used to describe specified embodiments and are not intended to limit the scope of other embodiments. The terms of a singular form may include plural forms unless otherwise specified. All of the terms used herein, which include technical or scientific terms, may have the same meaning that is generally understood by a person skilled in the art. It will be further understood that terms, which are defined in a dictionary, may be interpreted as having the same or similar meanings as or to contextual meanings of the relevant related art and not in an idealized or overly formal way, unless expressly so defined herein in the present disclosure. In some cases, even if the terms are terms which are defined in the specification, they should not be interpreted as excluding embodiments of the present disclosure.

In various embodiments of the present disclosure described below, hardware-wise approach methods will be described by way of an example. However, various embodiments of the present disclosure include technology using both hardware and software, and thus do not exclude software-based approach methods.

The present disclosure relates to an apparatus and a method for recovering a service after AN release is performed for a terminal which has received a multicast service in a wireless communication system. Specifically, the present disclosure relates to a method for continuing a multicast service when AN release is needed in a process of transmitting multicast data to a terminal in a wireless communication system, and describes a technology for smooth multicast data transmission to a terminal in a 5G network.

As used herein, terms indicating signals, terms indicating channels, terms indicating control information, terms indicating network entities, terms indicating components of a device are merely examples for convenience of explanation. Accordingly, the present disclosure is not limited to the terms described below, and other terms having the same technical meanings may be used.

In addition, various embodiments of the present disclosure will be described by using terms defined in some communication standards (for example, 3^{rd} generation partnership project (3GPP)), but this is merely an example for explanation. Various embodiments of the present disclosure may be easily modified and applied to other communication systems.

Hereinafter, a multicast service will be described. In order to provide a multicast service, a 5G system (5GS) may receive multicast service data from an application function (AF) or a contents provider, and may deliver the multicast service data to a new generation-radio access network (NG-RAN) to send the multicast service data to terminals that subscribe to the multicast service. A method of transmitting multicast data to an NG-RAN which is a base station of a 5G network in a 5G core network may include two methods of shared delivery and individual delivery. When the NG-RAN has multicast/broadcast service (MBS) capability, multicast service data may be transmitted through a tunnel for shared delivery from a user plane function providing the multicast/broadcast service (multicast/broadcast user plane function (MB-UPF)) to the NG-RAN. On the other hand, when the NG-RAN does not have the MBS capability, shared delivery may be impossible, and therefore, individual delivery may be employed, so that MBS data received through the MB-UPF may be transmitted to a terminal through a tunnel from the corresponding UPF to the NG-RAN through an associated PDU session.

When a multicast session for the multicast service is deactivated, the tunnel for the shared delivery and the tunnel for the individual delivery may be deactivated or released, and also, the terminals which have received the multicast service may transit (or, switch) to an idle state.

However, even when the multicast session is activated and a terminal receives a service from the NG-RAN supporting multicast, there may be a need for AN release for the terminal in the NG-RAN or an access and mobility management function (AMF). Accordingly, when the AN release is performed, the terminal may go into an idle state, and, even when the NG-RAN receives multicast service data, the NG-RAN may not transmit the multicast service data to the terminal, which subscribes to the multicast session, although the multicast session is activated since the NG-RAN does not have information regarding the terminal.

In addition, since multicast data is transmitted from the MB-UPF to the NG-RAN through shared delivery, paging for transmitting multicast service data to the terminal in the idle mode (or, dormant mode) may not be performed on the UPF or session management function (SMF) with respect to an associated PDU session. To this end, the terminal may not continuously receive the multicast service. The present disclosure is provided to solve the above-described problems.

An apparatus and a method according to various embodiments, which will be described hereinbelow, may enable an activated multicast service to be continuously used even when a terminal using a multicast service in a 5GS goes into an idle state due to AN release.

In the following descriptions, terms and names defined in standards for 5G systems will be used for convenience of explanation. However, the present disclosure is not limited to the above-described terms and names, and may be equally applied to a system conforming to other standards.

FIG. 1 illustrates a 5GS structure for a multicast service in a wireless communication system according to various embodiments of the present disclosure.

Referring to FIG. 1, the 5GS may include user equipment (UE) 101, an NG-RAN 102 which is a base station, an AMF device 103, an MB-UPF device 105, a multicast/broadcast-session management function (MB-SMF) device 107, a policy control function (PCF) device 109, an SMF device 111, a network exposure function (NEF) device 113, a multicast/broadcast service function (MBSF) device 115, a multicast/broadcast service traffic function (MBSTF) device 117, an application function (AF) device or a contents provider 119, and a unified data management (UDM) device 121, a user plane function (UPF) device 123, an authentication server function (AUSF) device 125, and an NF repository function (NRF) device 127.

Referring to FIG. 1, respective network functions (NFs) of the 5GS will be described in terms of “network function devices” or “network functions.” However, a person skilled in the art may know that an NF and/or NF device is implemented by specific one or two or more servers, and two or more NFs performing the same operation are implemented by one server.

One NF or two or more NFs may be implemented in the form of one network slice according to circumstances. The network slice may be generated based on a specific purpose. For example, the network slice may be set for a subscriber group to provide a service of the same type, such as a maximum transmission rate, data usage, a guaranteed minimum transmission rate, to specific subscriber groups. In addition, the network slice may be implemented according to various purposes. Herein, additional explanation of the network slice will be omitted.

Referring to FIG. 1, FIG. 1 illustrates interfaces between nodes. An Uu interface may be used between the UE 101 and the NG-RAN 102, an N2 interface may be used between the NG-RAN 102 and the AMF 103, an N3 interface may be used between the NG-RAN 102 and the UPF 123, and an N3mb interface may be used between the NG-RAN 102 and the MB-UPF 105. In addition, an N4mb interface may be used between the MB-UPF 105 and the MB-SMF 107, and an N19mb may be used between the MB-UPF 105 and the UPF 123. An N4 interface may be used between the SMF 111 and the UPF 123, an N6 interface may be used between the UPF 123 and the AF 119, and an Nmb2 interface may be used between the MBSF 115 and the MBSTF 117. In addition, an Nmb9 interface may be used between the MB-UPF 105 and the MBSTF 117. In addition, an Mmb8/xMB-U/MB2 interface may be used between the AF 119 and the MBSTF 117.

The above-described interfaces are defined in NR standards, and herein, additional description thereof will be omitted.

In order to support an MBS service in the 5GS, a cellular system for MBS may be configured with the following network function (NF) devices and services.

The AF 119 may be, for example, a V2X application server, a cellular Internet of things (CIoT) application server, a mission-critical push-to-talk (MCPTT) application, a contents provider, a TV or audio service provider, a streaming video service provider, etc.

The AF 119 may request the MBSF 115, which is an NF for managing a session of an MBS service and controlling traffic, to provide an MBS service in order to provide the MBS service. The MBSF 115 may be an NF that receives a request for the MBS service from the AF 119, and manages a corresponding MBS service session and controls corresponding MBS service traffic. In addition, the MBSTF 117 may be an NF that receives a media from the AF providing an MBS, from an application server (AS) providing an MBS, or from a content provider, based on control of the MBSF 115, and processes media traffic, and may operate as an MBS service anchor in the 5GS.

Alternatively, in a 5G core network (5GC), an MBS system may be configured and operated without including the MBSF 115 and the MBSTF 117. When the MBSF 115 and the MBSTF 117 are not included, the AF 119 may directly request the MB-SMF 107 or may request the MB-SMF 107 through the NEF 113 to provide the MBS service. In this case, MBS data may be provided to the 5G network from the application server (AS) providing the MBS or the contents provider through the MB-UPF 105.

In the present disclosure, the AF 119 may be an application server (AS) for providing a specific multicast/broadcast application service. Accordingly, hereinafter, it will be understood that the AS is the same as the AF 119 or the AF 119 exists along with the AS. The AF 119 may transmit, to the MBSF 115, a request for providing the MBS service to the UE 101 in order to provide the MBS service. Then, the MBSF 115 may control the MBSTF 117, which is an MBS service media anchor in the 5GS to transmit MBS service traffic to the UE 101, to provide the MBS service to the UE 101. In this case, the MBS service may refer to data that results from a multicast/broadcast service received from a specific contents provider.

According to an embodiment, the MBSF 115 and the MBSTF 117 may be integrated into one entity or one NF. In another embodiment, the MBSF 117 may be integrated into the NEF 113 or another NF. In still another embodiment, in the 5GS without the MBSF 115 and the MBSTF 117, the AF 119 may directly request the MB-SMF 107 to provide the MBS service, and the MB-UPF 105 may receive a media from the AS or the contents provider which is the AF 119 and may forward traffic.

The MBS service session may be managed through the MBSF 115 and the MBSTF 117, and service traffic may occur. When the service traffic is transmitted to the UE 101 through multicast/broadcast, an MBS session may be assigned and the corresponding traffic may be managed. That is, the MBSF 115 may correspond to a control plane that manages the MBS session, and the MBSTF 117 may correspond to a user lane that deals with traffic.

In the present disclosure, a “multimedia broadcast-multicast service gateway-control plane (MBMS-GW-C) service” may refer to a control function or a service that generates an MBS context regarding an MBS PDU session, manages the MBS session, and transmits traffic of the MBS session to the NG-RAN 102 which is a base station through IP multicast.

The MBMS-GW-C service may be integrated into the existing SMF 111, which manages a unicast PDU session, to be configured as the SMF 111 having an MBS session control function, or may be configured as a separate NF. An NF which supports the MBMS-GW-C service and has a function of the existing SMF will be referred to as the MB-SMF 107 in the present disclosure.

In addition, a service that transmits traffic, which is received from the MB-UPF 105 according to an MBS context regarding the MBS PDU session, to the NG-RAN 102, which performs multicast/broadcast according to the MBMS-GW-C service, through IP multicast will be referred to as a multimedia broadcast-multicast service gateway-user plane (MBMS-GW-U) service.

The MBMS-GW-U service may be integrated into the existing UPF, which processes the unicast PDU session, to be configured as a UPF having a function of transmitting MBS traffic to the appropriate NG-RAN 102 through IP multicast, or may be configured as a separate NF as shown in FIG. 1. Accordingly, in the present disclosure, an NF which supports the MBMS-GW-U service and has the function of the existing UPF will be referred to as the MB-UPF 105.

In order for the MBMS-GW-C service to control the MBMS-GW-U service, the N4mb interface may be used as described above.

In describing various embodiments of the present disclosure, the MBMS-GW-C and the MBMS-GW-U will be described under names of the SMF 111 and the UPF 123 or as the MB-SMF 107 and the MB-UPF 105, respectively, for convenience of explanation. However, when necessary, various embodiments will be described without confusion by describing whether purposes of the MBMS-GW-C and the MBMS-GW-U are dedicated to unicast or are dedicated to multicast/broadcast, or support both of them.

MBS traffic may be transmitted from the MBMS-GW-U (or UPF or MB-UPF) to the NG-RANs 102. For example, the MBS traffic may be transmitted to the NG-RAN 102 by using IP multicast. In this case, a tunnel between the MBMS-GW-U (or UPF or MB-UPF) and the NG-RAN 102 will be referred to as a shared delivery tunnel or a shared N3 tunnel. In the following descriptions, this tunnel will be referred to as a shared delivery tunnel or a shared tunnel.

In order to set an M1 tunnel, the MBMS-GW-C (or SMF or MB-SMF) may transmit a control message to the NG-RAN 102 through the AMF 103.

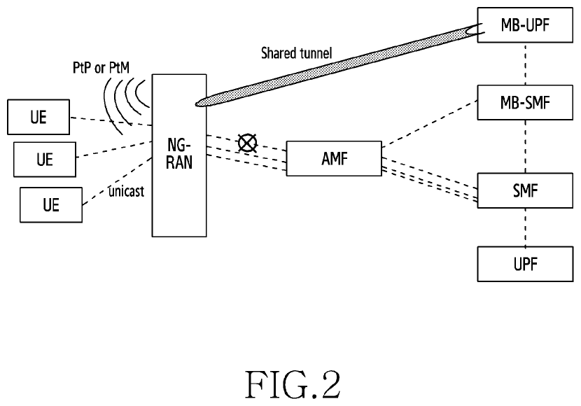

FIG. 2 illustrate a state in which a terminal which has received a multicast service in a wireless communication system does not continuously receive the multicast service when AN release is performed according to various embodiments of the present disclosure.

Referring to FIG. 2, multicast service data may be transmitted to an NG-RAN through a shared tunnel when a multicast session is activated. FIG. 2 illustrates a state in which AN release to release a link between the NG-RAN and an AMF, that is, an N2 session, occurs with respect to one terminal when the NG-RAN transmits data to terminals.

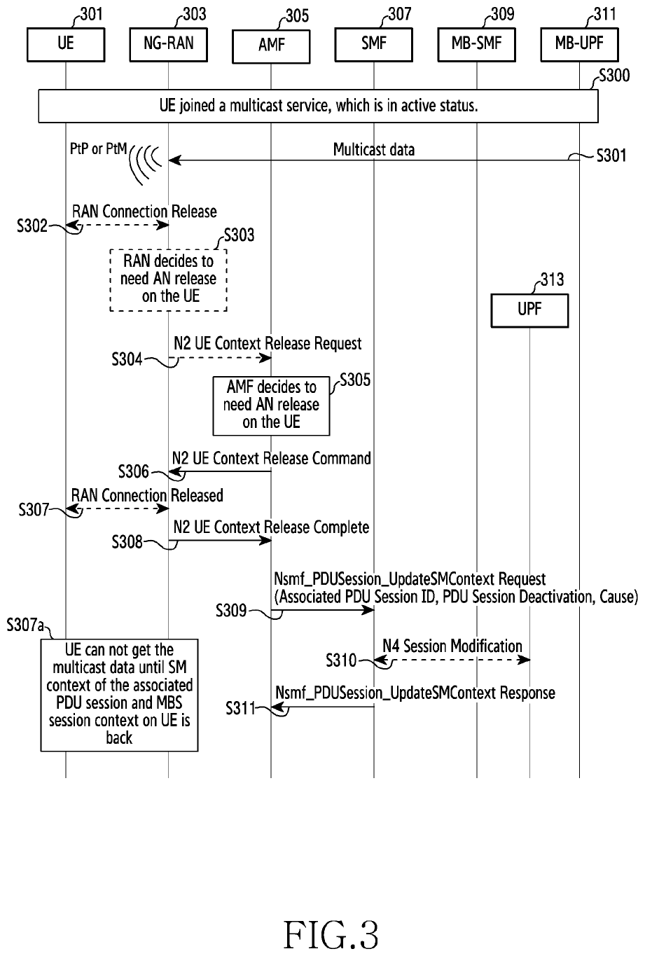

FIG. 3 illustrate a signal flowchart for a state in which a terminal which has received a multicast service in a wireless communication system does not continuously receive the multicast service when AN release is performed according to various embodiments of the present disclosure.

Referring to FIG. 3, at step S303, an NG-RAN 303 may know or identify that AN release is needed for a terminal (or, user equipment (UE)) 301. At step 304, the NG-RAN 303 may transmit an N2 UE context release request to an AMF 305, or, when occurrence of a problem on the terminal 301 is found or identified, the AMF 305 may decide to perform AN release on the terminal 301 as at step (e.g., AMF 305). At step S306, the AMF 305 may transmit an N2 UE context release command message to the NG-RAN 303. When the NG-RAN 303 maintains radio resource control (RRC) connection with the terminal 301, the NG-RAN 303 may perform RAN connection release as at step S307. Through steps S308 to S311, the network may transit (or, switch) to an idle mode for the terminal 301, and accordingly, may deactivate a generated PDU session. In this process, an associated PUD session associated with a multicast session may also be deactivated. The terminal 301 may also transit (or, switch) to the idle mode after step S307 at which RAN connection is released, and in this case, as at step S307a, there may be a problem that the terminal 310 does not receive the multicast service until a session management context on the associated PDU session and an MBS session context on the terminal 301 are recovered.

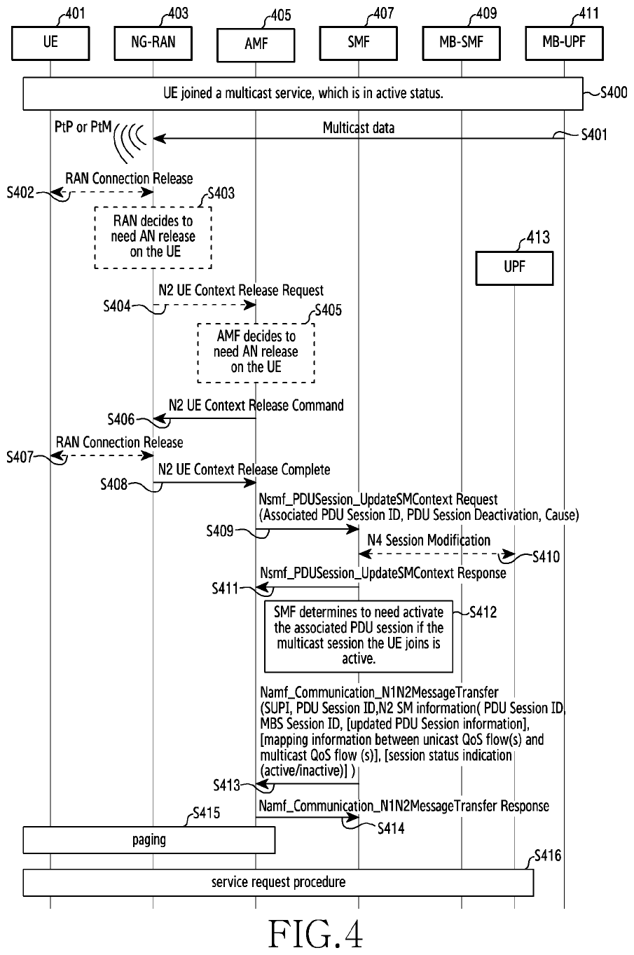

FIG. 4 illustrates a process of recovering a multicast service by requesting in a network after AN release is performed when a multicast session is activated in a wireless communication system according to various embodiments of the present disclosure.

Referring to FIG. 4, when a multicast session is activated, multicast service data may be transmitted to an NG-RAN 403 through a shared tunnel, and the NG-RAN 403 may transmit the multicast service data to terminals. In this case, AN release to release a link between the NG-RAN 403 and an AMF 405, that is, an N2 session, may be needed for one piece of UE 101. In this case, as at step 404, the NG-RAN 403 may transmit an N2 UE context release request to the AMF 405, or, when the AMF 405 finds that a problem regarding the terminal 401 (or, user equipment (UE)) occurs, the AMF 405 may decide to perform AN release on the terminal 401 as at step S405. At step S406, the AMF 405 may transmit an N2 UE context release command message to the NG-RAN 403. When the NG-RAN 403 maintains RRC connection with the terminal, the NG-RAN 403 may perform RAN connection release as at step S407. Through steps S408-S411, the network may transit (or, switch) to an idle mode for the terminal, and accordingly, may deactivate a generated PUD session. In this process, an associated PDU session associated with the multicast session may also be deactivated. In addition, the terminal 401 may transit (or, switch) to the idle mode after step S407 at which RAN connection is released.

When it is identified that the terminal 401 transits (or, switches) to the idle mode or the terminal 401 identifies that the associated PDU session associated with the multicast session is deactivated on receipt of a message of step S409, an SMF 407 may identify that the terminal 401 joins the multicast session or the SMF 407 may identify that the multicast session that the terminal 401 joins is activated. In this case, as at step 412, the SMF 407 may identify a need to start a procedure for activating the associated PDU session, and accordingly, at step S413, the SMF 407 may transmit, to the AMF 405, Namf_Communication_N1N2MessageTransfer including a PDU session ID, N2 SM information on a PDU session, information on the multicast session. The information on the multicast session may include an MBS session ID, unicast quality of service (QoS) flow information mapped onto a multicast QoS flow, information on a status of the multicast session.

The AMF 405 which receives the Namf_Communication_N1N2MessageTransfer message may page or notify the terminal 401 to perform a network triggered service request as at step S416. At step S416, the AMF 405 may deliver the N2 SM information included in the Namf_Communication_N1N2MessageTransfer message to the NG-RAN 403, such that the NG-RAN 403 receives a context for a multicast service on the terminal 401.

According to still another embodiment of the present disclosure, when the SMF 407 of the associated PDU session which receives the message of step S409 identifies that the terminal 401 transits (or, switches) to the idle mode or identifies that the associated PDU session associated with the multicast session is deactivated, the SMF 407 may transmit a reject message to the AMF 405 to maintain the associated PDU session without releasing through a response message, that is, Nsmf_PDUSession_UpdateSMContext Response, and the reject message may inform that the multicast session is active as a cause value. Accordingly, the terminal 401 may continuously service the multicast session and may perform release when the terminal 410 leaves (or, is removed from) the multicast session or the multicast session is deactivated.

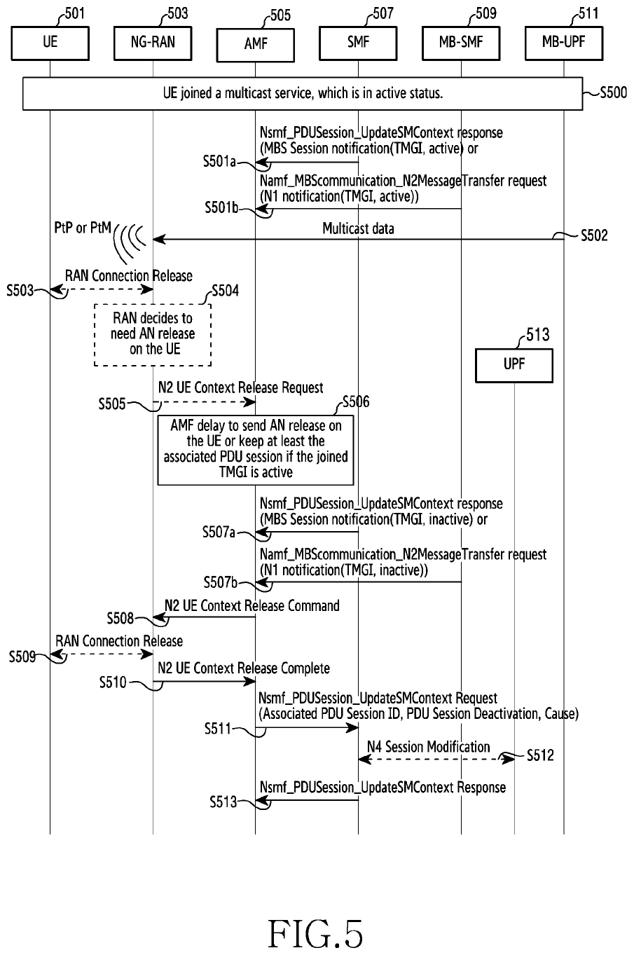

FIG. 5 illustrate a process of continuing a multicast service by maintaining an associated PDU session in a network when a multicast session is activated and AN release may be performed in a wireless communication system according to various embodiments of the present disclosure.

Referring to FIG. 5, it may be assumed that, when the multicast session is activated, an SMF 507 may inform an AMF 505 of the activated state of the multicast session as at step S501a, or an MB-SMF 509 informs the AMF 505 of the activated state of the multicast session as at step 501b. That is, it may be assumed that the AMF 505 knows about the status of an MBS session.

According to an embodiment, when multicast service data is transmitted to an NG-RAN 503 through a shared tunnel and the NG-RAN 503 transmits the multicast service data to terminals, AN release to release a link between the NG-RAN 503 and the AMF 505, that is, an N2 session, may be needed for one terminal 501. In this case, as at step S505, the NG-RAN 503 may transmit an N2 UE context release request to the AMF 505. Alternatively, when the AMF 505 finds a problem on the terminal 501, the AMF 505 may decide to perform AN release on the terminal 501 at step S506. However, when it is identified that the multicast session that the terminal joins is active, the AMF 505 may defer transmission of AN release to the NG-RAN 503 for the terminal 501 or may cancel, and may maintain at least the associated PDU session (or may control). Accordingly, the terminal 501 may continuously provide or perform the multicast session service, and, when the terminal 501 leaves the multicast session or the multicast session is deactivated, the AN release which is deferred may be performed for the terminal 501.

According to another embodiment of the present disclosure, the terminal 501 which receives the N2 UE context release request message of step S505 may perform AN release, and may page or notify in order to activate the associated PDU session again.

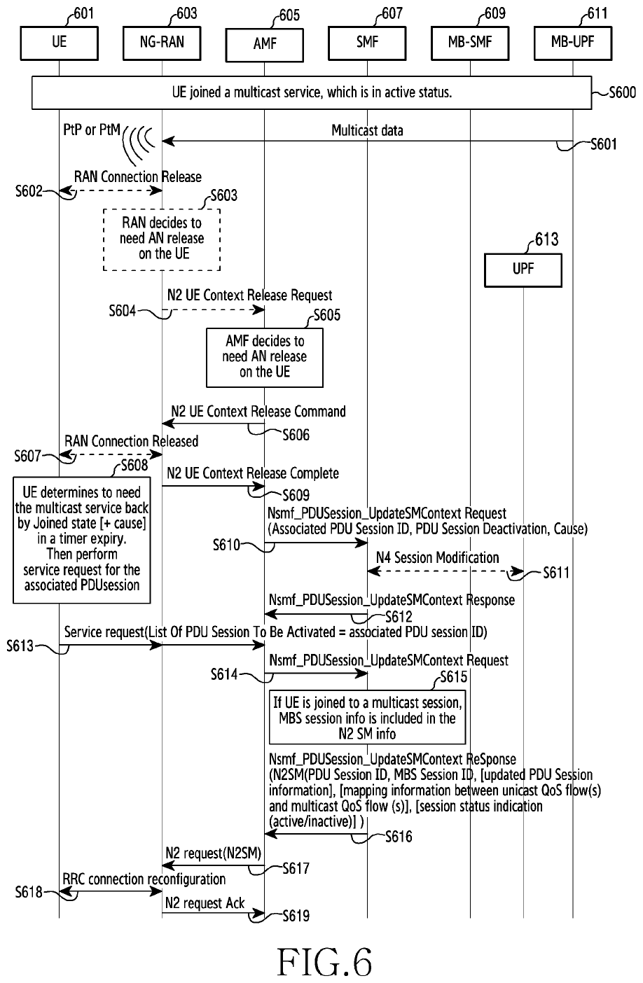

FIG. 6 illustrate a process of recovering a multicast service by requesting by a terminal after AN release is performed when a multicast session is activated in a wireless communication system according to various embodiments of the present disclosure.

Referring to FIG. 6, in an activated state of a multicast session, when multicast service data is transmitted to an NG-RAN 603 through a shared tunnel and the NG-RAN 603 transmits the multicast service data to terminals, and AN release to release a link between the NG-RAN 603 and an AMF 605, that is, an N2 session, is needed for one terminal 601, the NG-RAN 603 may transmit an N2 UE context release request to the AMF 605 as at step S604. Alternatively, when the AMF 605 finds a problem about the terminal 601, the AMF 605 may decide to perform AN release on the terminal 601 as at step (e.g., AMF 605), and may transmit an N2 UE context release command message to the NG-RAN 603.

When RRC connection with the corresponding terminal is still maintained, the NG-RAN 603 may perform RAN connection release as at step S607. Through steps S608-S612, the network may transit (or, switch) to an idle mode for the terminal, and accordingly, may deactivate a generated PDU session. In this process, an associated PDU session associated with the multicast session may also be deactivated. In addition, the terminal 601 may transits (or, switch) to the idle mode after step S607 at which RAN connection is released.

When the terminal 601 which receives the message of step S607 and transits (or, switches) to the idle mode knows that the multicast session is identified, a predetermined timer value may be applied to the terminal 601, and, when the timer value expires, the terminal 601 may perform a service request with respect to the associated PDU session.

When the terminal 601 joins the multicast session, an SMF 607 which receives a message of step S614 and manages the associated PDU session may transmit N2 SM information on the associated PDU session to the NG-RAN 603. The N2 SM information may include information on the multicast session. The information on the multicast session may include an MBS session ID, unicast QoS flow information mapped onto a multicast QoS flow, and information on a status of the multicast session. Accordingly, the NG-RAN 603 may continuously transmit the multicast data to the terminal 601.

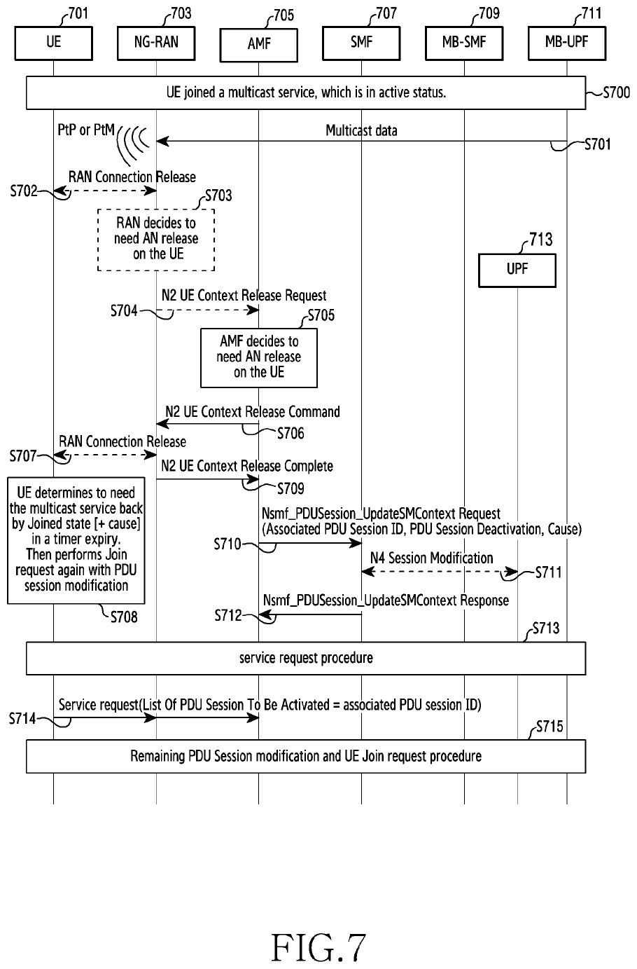

FIG. 7 illustrate a process of recovering a multicast service by requesting by a terminal after AN release is performed when a multicast session is activated in a wireless communication system according to various embodiments of the present disclosure.

Referring to FIG. 7, in an activated state of a multicast session, when multicast service data is transmitted to an NG-RAN 703 through a shared tunnel and the NG-RAN 703 transmits the multicast service data to terminals, and AN release to release a link between the NG-RAN 703 and an AMF 705, that is, an N2 session, is needed for one terminal 701, the NG-RAN 703 may transmit an N2 UE context release request to the AMF 705 as at step S704. Alternatively, when the AMF 705 finds a problem about the terminal 701, the AMF 705 may decide to perform AN release on the terminal 701 as at step (e.g., AMF 705), and may transmit an N2 UE context release command message to the NG-RAN 703. When RRC connection with the corresponding terminal is still maintained, the NG-RAN 703 may perform RAN connection release as at step S707. Through steps S709-S712, the network may transit (or, switch) to a idle mode for the terminal, and accordingly, may deactivate a generated PDU session. In this process, an associated PDU session associated with the multicast session may also be deactivated. In addition, the terminal 701 may transit (or, switch) to the idle mode after step S707 at which RAN connection is released.

When the terminal 701 which receives the message of step S707 and transits (or, switches) to the idle mode knows that the multicast session is identified, a predetermined timer value may be applied to the terminal 701, and, when the timer value expires, the terminal 701 may request to join multicast by using the associated PDU session. To achieve this, the terminal may perform a service request to transmit a PDU session modification request.

Meanwhile, an SMF 707 which receives a message of step S714 and manages the associated PDU session may control the terminal 701 to join the multicast session, and accordingly, the NG-RAN 703 may recover data on the multicast session for the terminal 701 and may continuously transmit the multicast data again.

According to an embodiment, a method performed by a session management function (SMF) in a mobile communication system is provided. The method may comprise receiving information for a multicast/broadcast service protocol data unit (MBS PDU) session associated with a user equipment (UE) in an idle state, the MBS PDU session being in an active state and transmitting, to an access and mobility management function (AMF), information indicating that the UE in the idle state joins the MBS PDU session. The information indicating that the UE joins the MBS PDU session is used for a radio resource control (RRC) connection reconfiguration with the UE in the idle state.

The information for the MBS PDU session is received from the AMF based on a service request for a MBS service from the UE. The service request for the MBS service is received from the UE in case that a timer for the MBS expires.

The information indicating that the UE joins the MBS PDU session includes information for PDU session identifications (IDs) and a quality of service (QoS), and the service request includes a list of allowed PDU sessions.

The receiving of the information for the MBS PDU session is triggered by a network including the SMF.

The UE transits to the idle state based on access network (AN) release.

According to an embodiment, a session management function (SMF) in a mobile communication system is provided. The SMF comprises a transceiver and a controller coupled to the transceiver. The controller is configured to receive information for a multicast/broadcast service protocol data unit (MBS PDU) session associated with a user equipment (UE) in an idle state, the MBS PDU session being in an active state, and transmit, to an access and mobility management function (AMF), information indicating that the UE in the idle state joins the MBS PDU session. The information indicating that the UE joins the MBS PDU session is used for a radio resource control (RRC) connection reconfiguration with the UE in the idle state.

The information for the MBS PDU session is received from the AMF based on a service request for a MBS service from the UE. The service request for the MBS service is received from the UE in case that a timer for the MBS expires.

The information indicating that the UE joins the MBS PDU session includes information for PDU session identifications (IDs) and a quality of service (QoS). The service request includes a list of allowed PDU sessions.

The receiving of the information for the MBS PDU session is triggered by a network including the SMF.

The UE transits to the idle state based on access network (AN) release.

According to an embodiment, a method performed by an access and mobility management function (AMF) in a mobile communication system is provided. The method comprises transmitting, to a session management function (SMF), information for a multicast/broadcast service protocol data unit (MBS PDU) session associated with a user equipment (UE) in an idle state, the MBS PDU session being in an active state and receiving, from the SMF, information indicating that the UE in the idle state joins the MBS PDU session. The information indicating that the UE joins the MBS PDU session is used for a radio resource control (RRC) connection reconfiguration with the UE in the idle state.

The information for the MBS PDU session is transmitted to the SMF based on a service request for a MBS service. The service request for the MBS service is received from the UE in case that a timer for the MBS expires.

The information indicating that the UE joins the MBS PDU session includes information for PDU session identifications (IDs) and a quality of service (QoS), and the service request includes a list of allowed PDU sessions.

The transmitting of the information for the MBS session is triggered by a network including the AMF.

The UE transits to the idle state based on access network (AN) release.

According to an embodiment, an access and mobility management function (AMF) in a mobile communication system is provided. The AMF comprises a transceiver and a controller coupled to the transceiver. The controller is configured to transmit, to a session management function (SMF), information for a multicast/broadcast service protocol data unit (MBS PDU) session associated with a user equipment (UE) in an idle state, the MBS PDU session being in an active state and receive, from the SMF, information indicating that the UE in the idle state joins the MBS PDU session. The information indicating that the UE joins the MBS PDU session is used for a radio resource control (RRC) connection reconfiguration with the UE in the idle state.

The information for the MBS PDU session is transmitted to the SMF based on a service request for a MBS service, and the service request for the MBS service is received from the UE in case that a timer for the MBS expires.

The information indicating that the UE joins the MBS PDU session includes information for PDU session identifications (IDs) and a quality of service (QoS), and the service request includes a list of allowed PDU sessions.

The transmitting of the information for the MBS session is triggered by a network including the AMF.

The UE transits to the idle state based on access network (AN) release.

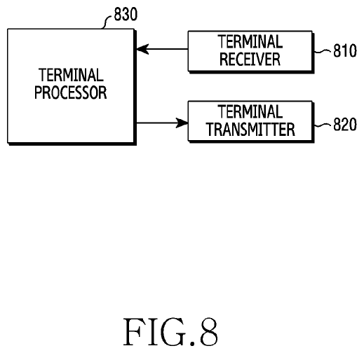

FIG. 8 illustrate a structure of a terminal according to an embodiment of the present disclosure.

Referring to FIG. 8, the terminal may include a terminal receiver 810, a terminal transmitter 820, and a terminal processor (e.g., controller) 830.

The terminal receiver 810 and the terminal transmitter 820 may be referred to as a transceiver all together. According to the communication method of the terminal described above, the terminal receiver 810, the terminal transmitter 820, and the terminal processor 830 of the terminal may operate. However, components of the terminal are not limited to the above-described example. For example, the terminal may include more components (for example, a memory, etc.) or fewer components than the above-described components. In addition, the terminal receiver 810, the terminal transmitter 820, and the terminal processor 830 may be implemented in the form of one chip.

The terminal receiver 810 and the terminal transmitter 820 (or transceiver) may transmit and receive signals to and from a base station. Herein, the signal may include control information and data. To achieve this, the transceiver may include a radio frequency (RF) transmitter to up-convert and amplify a frequency of a transmitted signal, and an RF receiver to perform low noise amplification with respect to a received signal and to down-convert a frequency. However, this is merely an embodiment of the transceiver and components of the transceiver are not limited to the RF transmitter and the RF receiver.

In addition, the transceiver may receive a signal through a wireless channel and may output the signal to the terminal processor 830, and may transmit a signal outputted from the terminal processor 830 through the wireless channel.

A memory (not shown) may store a program and data necessary for operations of the terminal. In addition, the memory may store control information or data included in a signal acquired by the terminal. The memory may be configured by a storage medium such as a read only memory (ROM), a random access memory (RAM), a hard disk, a CD-ROM and a DVD, or a combination of the storage media.

The terminal processor 830 may control a series of processes, such that the terminal operates according to the above-described embodiment of the present disclosure. The terminal processor 830 may be implemented by a circuit or an application specific integrated circuit or at least one processor. The terminal processor 830 may be implemented by a controller or one or more processors.

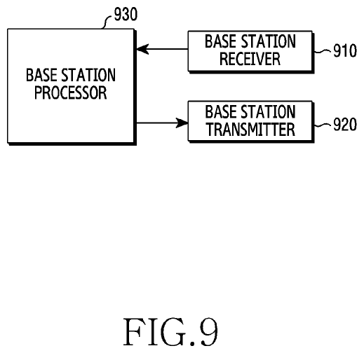

FIG. 9 illustrate a structure of a base station according to an embodiment of the present disclosure.

Referring to FIG. 9, the base station may include a base station receiver 910, a base station transmitter 920, and a base station processor (e.g., controller) 930.

The base station receiver 910 and the base station transmitter 920 may be referred to as a transceiver all together. According to the communication method of the base station described above, the base station receiver 910, the base station transmitter 920, and the base station processor 930 of the base station may operate. However, components of the base station are not limited to the above-described example. For example, the base station may include more components (for example, a memory, etc.) or fewer components than the above-described components. In addition, the base station receiver 910, the base station transmitter 920, and the base station processor 930 may be implemented in the form of one chip.

The base station receiver 910 and the base station transmitter 920 (or transceiver) may transmit and receive signals to and from a terminal and/or a network entity. Herein, the signal may include control information and data. To achieve this, the transceiver may include an RF transmitter to up-convert and amplify a frequency of a transmitted signal, and an RF receiver to perform low noise amplification with respect to a received signal and to down-convert a frequency. However, this is merely an embodiment of the transceiver and components of the transceiver are not limited to the RF transmitter and the RF receiver.

In addition, the transceiver may receive a signal through a wired and/or wireless channel and may output the signal to the base station processor 930, and may transmit a signal outputted from the base station processor 930 through the wired or wireless channel.

A memory (not shown) may store a program and data necessary for operations of the base station. In addition, the memory may store control information or data included in a signal acquired by the base station. The memory may be configured by a storage medium such as a ROM, a RAM, a hard disk, a CD-ROM and a DVD, or a combination of the storage media.

The base station processor 930 may control a series of processes, such that the base station operates according to the above-described embodiment of the present disclosure. The base station processor 930 may be implemented by a controller or one or more processors.

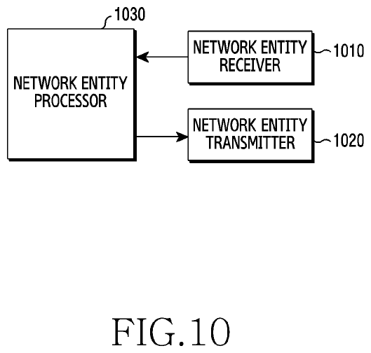

FIG. 10 illustrate a structure of a network entity according to an embodiment of the present disclosure.

Referring to FIG. 10, the network entity may include a network entity receiver 1010, a network entity transmitter 1020, and a network entity processor (e.g., controller) 1030. Herein, the network entity may include an AMF, an SMF, a UPF, a DN, an NSSF, an NEF, an AUSF, an NRF, a PCF, a UDM, an AF, etc.

The network entity receiver 1010 and the network entity transmitter 1020 may be referred to as a transceiver all together. According to the communication method of the network entity described above, the network entity receiver 1010, the network entity transmitter 1020, and the network entity processor 1030 of the network entity may operate. However, components of the network entity are not limited to the above-described example. For example, the network entity may include more components (for example, a memory, etc.) or fewer components than the above-described components. In addition, the network entity receiver 1010, the network entity transmitter 1020, and the network entity processor 1030 may be implemented in the form of one chip.

The network entity receiver 1010 and the network entity transmitter 1020 (or transceiver) may transmit and receive signals to and from a base station and/or another network entity. Herein, the signal may include control information and data. The transceiver may receive a signal through a wired and/or wireless channel and may output the signal to the network entity processor 1030, and may transmit a signal outputted from the network entity processor 1030 through the wired or wireless channel.

A memory (not shown) may store a program and data necessary for operations of the network entity. In addition, the memory may store control information or data included in a signal acquired by the network entity. The memory may be configured by a storage medium such as a ROM, a RAM, a hard disk, a CD-ROM and a DVD, or a combination of the storage media.

The network entity processor 1030 may control a series of processes, such that the network entity operates according to the above-described embodiment of the present disclosure. The network entity processor 1030 may be implemented by a controller or one or more processors.

Embodiments disclosed herein provide an apparatus and a method for smooth multicast data transmission to a terminal in a 5G network in a wireless communication system.

The effect achieved by the present disclosure is not limited to those mentioned above, and other effects that are not mentioned above may be clearly understood to those skilled in the art based on the description provided above.

Methods based on the claims or the embodiments disclosed in the present disclosure may be implemented in hardware, software, or a combination of both.

When implemented in software, a computer readable storage medium for storing one or more programs (software modules) may be provided. The one or more programs stored in the computer readable storage medium are configured for execution performed by one or more processors in an electronic device. The one or more programs include instructions for allowing an electronic device to execute the methods based on the claims or the embodiments disclosed in the present disclosure.

The program (the software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may access via an external port to a device which performs the embodiments of the present disclosure. In addition, an additional storage device on a communication network may access to a device which performs the embodiments of the present disclosure.

In the above-described specific embodiments of the present disclosure, elements included in the present disclosure are expressed in singular or plural forms according to specific embodiments. However, singular or plural forms are appropriately selected according to suggested situations for convenience of explanation, and the present disclosure is not limited to a single element or plural elements. An element which is expressed in a plural form may be configured in a singular form or an element which is expressed in a singular form may be configured in plural number.

An order of explanation on the drawings describing embodiments of the present disclosure does not necessarily correspond to an order of execution, and the order of operations may be changed or operations may be performed in parallel. In addition, the drawings describing embodiments of the present disclosure may omit some components or may include only some component without departing from the essence of the present disclosure.

In addition, embodiments of the present disclosure may be executed in combination of a part or an entirety of contents included in the respective embodiments without departing from the essence of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a session management function (SW) in a mobile communication system, the method comprising:
receiving information for a multicast/broadcast service protocol data unit (MBS PDU) session associated with a user equipment (UE) in an idle state, the MBS PDU session being in an active state; and
transmitting, to an access and mobility management function (AMF), information indicating that the UE in the idle state joins the MBS PDU session,
wherein the information indicating that the UE joins the MBS PDU session is used for a radio resource control (RRC) connection reconfiguration with the UE in the idle state.

2. The method of claim 1, wherein the information for the MBS PDU session is received from the AMF based on a service request for a MBS service from the UE, and wherein the service request for the MBS service is received from the UE in case that a timer for the MBS expires.

3. The method of claim 2, wherein the information indicating that the UE joins the MBS PDU session includes information for PDU session identifications (IDs) and a quality of service (QoS), and wherein the service request includes a list of allowed PDU sessions.

4. The method of claim 1, wherein the receiving of the information for the MBS PDU session is triggered by a network including the SMF.

5. The method of claim 1, wherein the UE transits to the idle state based on an access network (AN) release.

6. A session management function (SMF) in a mobile communication system, the SMF comprising:
a transceiver; and
a controller coupled to the transceiver, the controller configured to:
receive information for a multicast/broadcast service protocol data unit (MBS PDU) session associated with a user equipment (UE) in an idle state, the MBS PDU session being in an active state, and
transmit, to an access and mobility management function (AMF), information indicating that the UE in the idle state joins the MBS PDU session,
wherein the information indicating that the UE joins the MBS PDU session is used for a radio resource control (RRC) connection reconfiguration with the UE in the idle state.

7. The SMF of claim 6, wherein the information for the MBS PDU session is received from the AMF based on a service request for a MBS service from the UE, and wherein the service request for the MBS service is received from the UE in case that a timer for the MBS expires.

8. The SMF of claim 7, wherein the information indicating that the UE joins the MBS PDU session includes information for PDU session identifications (IDs) and a quality of service (QoS), and wherein the service request includes a list of allowed PDU sessions.

9. The SMF of claim 6, wherein the receiving of the information for the MBS PDU session is triggered by a network including the SMF.

10. The SMF of claim 6, wherein the UE transits to the idle state based on an access network (AN) release.

11. A method performed by an access and mobility management function (AMF) in a mobile communication system, the method comprising:
transmitting, to a session management function (SMF), information for a multicast/broadcast service protocol data unit (MBS PDU) session associated with a user equipment (UE) in an idle state, the MBS PDU session being in an active state; and
receiving, from the SMF, information indicating that the UE in the idle state joins the MBS PDU session,
wherein the information indicating that the UE joins the MBS PDU session is used for a radio resource control (RRC) connection reconfiguration with the UE in the idle state.

12. The method of claim 11, wherein the information for the MBS PDU session is transmitted to the SMF based on a service request for a MBS service, and wherein the service request for the MBS service is received from the UE in case that a timer for the MBS expires.

13. The method of claim 12, wherein the information indicating that the UE joins the MBS PDU session includes information for PDU session identifications (IDs) and a quality of service (QoS), and wherein the service request includes a list of allowed PDU sessions.

14. The method of claim 11, wherein the transmitting of the information for the MBS session is triggered by a network including the AMF.

15. The method of claim 11, wherein the UE transits to the idle state based on an access network (AN) release.

16. An access and mobility management function (AMF) in a mobile communication system, the AMF comprising:
a transceiver; and
a controller coupled to the transceiver, the controller configured to:
transmit, to a session management function (SMF), information for a multicast/broadcast service protocol data unit (MBS PDU) session associated with a user equipment (UE) in an idle state, the MBS PDU session being in an active state, and
receive, from the SMF, information indicating that the UE in the idle state joins the MBS PDU session,
wherein the information indicating that the UE joins the MBS PDU session is used for a radio resource control (RRC) connection reconfiguration with the UE in the idle state.

17. The AMF of claim 16, wherein the information for the MBS PDU session is transmitted to the SMF based on a service request for a MBS service, and wherein the service request for the MBS service is received from the UE in case that a timer for the MBS expires.

18. The AMF of claim 17, wherein the information indicating that the UE joins the MBS PDU session includes information for PDU session identifications (IDs) and a quality of service (QoS), and wherein the service request includes a list of allowed PDU sessions.

19. The AMF of claim 16, wherein the transmission of the information for the MBS session is triggered by a network including the AMF.

20. The AMF of claim 16, wherein the UE transits to the idle state based on an access network (AN) release.
